(19) United States
(12) Patent Application Publication
(10) Pub. No.: US 2025/0204707 A1
(43) Pub. Date: Jun. 26, 2025

(54) STRAW

(71) Applicant: ECO FIN CO., LTD., Taoyuan City (TW)

(72) Inventors: Dai Tan YANG, Taoyuan City (TW); Pao Tan CHEN, Taoyuan City (TW)

(21) Appl. No.: 18/643,198

(22) Filed: Apr. 23, 2024

(30) Foreign Application Priority Data
Dec. 22, 2023 (EP) 23219920.8

(51) Int. Cl. A47G 21/18

(52) U.S. Cl. CPC A47G 21/18

(57) ABSTRACT

A straw is disclosed. The straw comprises a tubular straw body having an end, and formed of a substrate, wherein the substrate has a first long side, a second long side, and a first thickness. The first long side overlaps with the second long side to form an overlapping portion having a second thickness. The straw is characterized in that a ratio of the second thickness to the first thickness is smaller than 2.

### CROSS-REFERENCE TO RELATED APPLICATION AND CLAIM OF PRIORITY

This application claims the benefit of the European Patent Application No. 23219920.8 filed on Dec. 22, 2023 at the European Patent Office, the disclosures of which are incorporated herein in their entirety by reference.

### FIELD OF THE INVENTION

The present invention is related to a straw, and more particularly to a straw with strong strength for piercing a sealing film at the opening of the paper cup and with a high level of durability to the liquid in the paper cup.

### BACKGROUND OF THE INVENTION

Straws widely used for drinking juice or soft drinks filled in hand-held paper cups are usually made of plastic materials. Presently, environmental awareness has become stronger in society, and as a consequence the straws made of plastic material have gradually been replaced by paper straws. However, a problem that has emerged is that the strength of paper straws is weaker than that of plastic straws, so it is easy for paper straws to collapse when being inserted into the sealing film at the opening of the paper cup. Besides, in comparison with plastic straws, paper straws easily soften and are less durable against liquid such as juice or soft drinks when soaked in them. Accordingly, traditional paper straws require thicker paper sheets to form the straws.

In addition, the paper straws of the prior art have a laminated membrane/coating film layer coated thereon for a better water-proof effect. However, the laminated membrane/coating film layer is usually selected from PE, wax or fluorochemicals, which is not environmentally friendly. Therefore, paper straws with a laminated membrane/coating film layer cannot be recycled, or can be recycled at extremely high cost to separate the materials of the coating and the paper material. If these paper straws are not recycled, they will not decompose in the natural environment.

In addition, the prior art paper straws contain per- and polyfluoroalkyl substances (PFAS), which have good chemical stability, are waterproof, oil-proof, and have low friction, and thus are widely used in the materials that contact food. However, PFAS is difficult to decompose in the natural environment, is harmful to the human body, and causes pollution to nature. Therefore, paper straws containing PFAS or fluorene are gradually not accepted by the market.

In addition, in the prior art, some straws are made by first cutting a paper sheet into a predetermined shape, and then adhering the cut paper sheet having a predetermined shape into a straw with a beveled end. This results in a very complicated and time-consuming manufacturing process for mass production. In consideration of the strength of the paper straw, a thicker paper sheet is used and cut into the predetermined shape, in the step of scrolling the cut thicker paper sheet prior to the step of adhesion, the cut thicker paper sheet does not scroll easily for the adhesion to form a paper straw, which causes another problem.

Another type of traditional straw is formed of a paper strip rather than a paper sheet. The paper strip is oblique or diagonally curled, and then adhered to form a paper straw. This type of straw has the same problem that it requires a thicker strip of paper to maintain its strength. In addition, since the adhesion area on the straw will be much larger than that of a straw made of the paper sheet, the risk of the peeling of the adhesion area of a straw formed by the thin paper strip will be higher.

Therefore, the Applicant has disclosed a straw to improve the problems of the prior art mentioned above.

### SUMMARY OF THE INVENTION

In accordance with one aspect of the present invention, a straw is provided. The straw includes a tubular straw body having an end and formed of a substrate, wherein the substrate has a first long side, a second long side, and a first thickness, the first long side overlaps with the second long side to form an overlapping portion having a second thickness, and the straw is characterized in that a ratio of the second thickness to the first thickness is smaller than 2.

### BRIEF DESCRIPTION OF THE DRAWINGS

The embodiments are depicted by the examples, and are therefore merely illustrative of inventive concepts.

FIG. 1A is a straw according to one embodiment of the present invention;

FIG. 1B is a straw according to another embodiment of the present invention;

FIG. 1C is a specific view of the straw in FIG. 1B;

FIG. 2 is another specific view of the straw in FIG. 1A or 1B;

FIG. 3A is a schematic side view of the substrate of the straw according to one embodiment of the present invention;

FIG. 3B is a schematic side view of the substrate of the straw according to another embodiment of the present invention;

FIG. 4 is a schematic diagram of a flattened shape of a substrate when flattened according to one embodiment of the present invention, which also shows a partial enlarged view of an end of the straw;

FIG. 5 is a schematic diagram of a flattened shape of a substrate when flattened according to another embodiment of the present invention, which also shows a partial enlarged view of an end of the straw;

FIG. 6A is a schematic diagram showing how to cut to form a straw according to one embodiment of the present invention; and

FIG. 6B is a schematic diagram showing how to cut to form a straw according to another embodiment of the present invention.

### DETAILED DESCRIPTION OF THE PREFERRED EMBODIMENTS

Please refer to all figures of the present invention when reading the following detailed description, wherein all figures of the present invention demonstrate different embodiments of the present invention by showing examples, and help the skilled person in the art to understand how to implement the present invention. The present examples provide sufficient embodiments to demonstrate the concept of the present invention, each embodiment does not conflict with the others, and new embodiments can be implemented through an arbitrary combination thereof, i.e., the present invention is not restricted to the embodiments disclosed in the present specification.

Unless there are other restrictions defined in the specific example, the following definitions apply to the terms used throughout the specification.

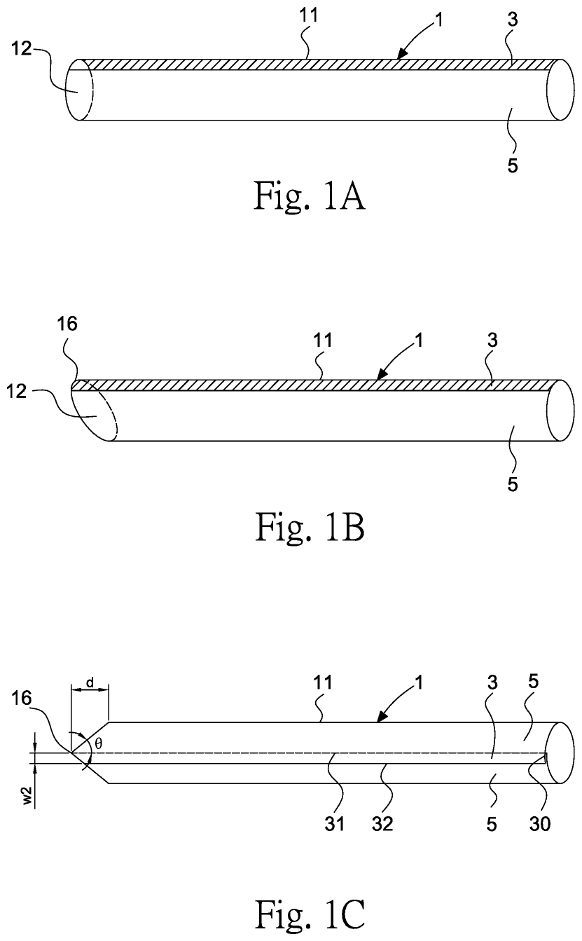

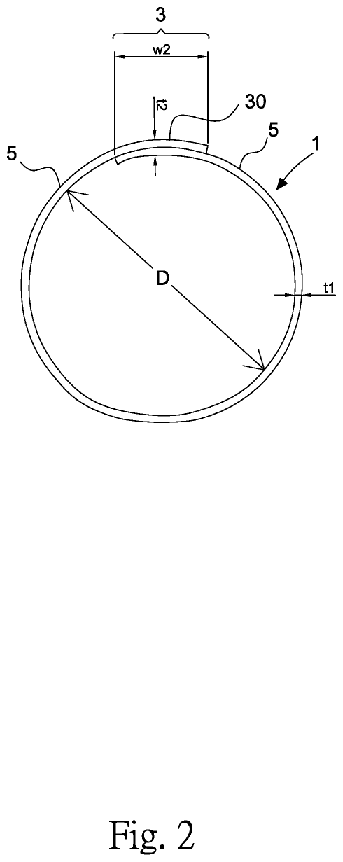

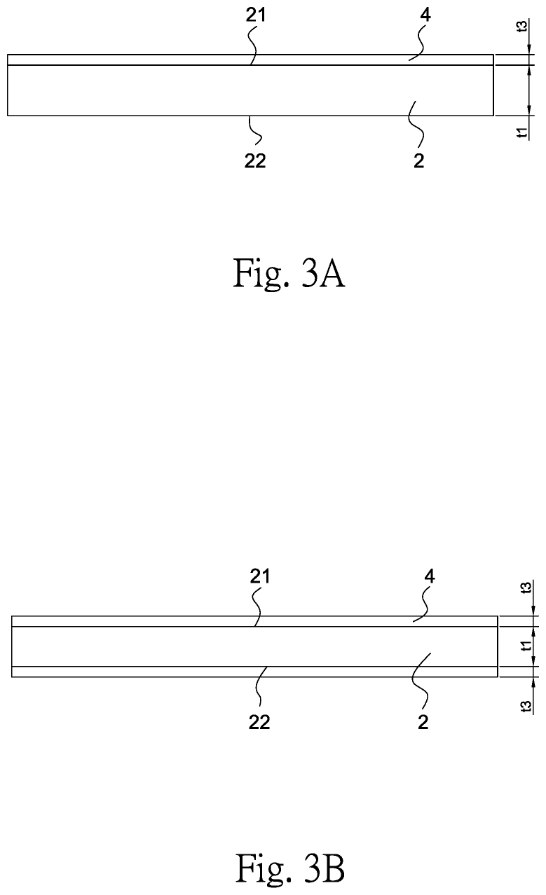

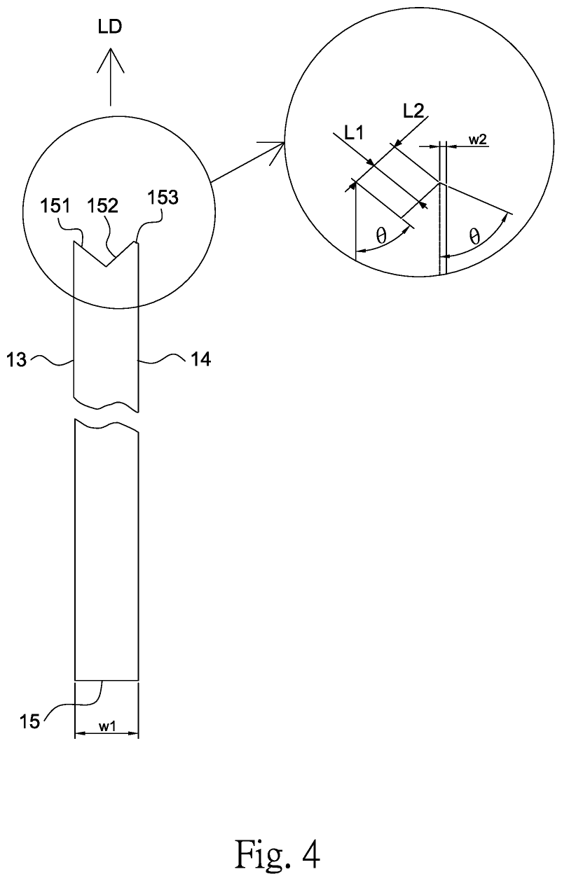

FIG. 1A is a straw according to one embodiment of the present invention. FIG. 1B is a straw according to another embodiment of the present invention. FIG. 1C is a specific view of the straw in FIG. 1B. FIG. 2 is another specific view of the straw in FIG. 1A or 1B. FIG. 3A is a schematic side view of the substrate of the straw according to one embodiment of the present invention. FIG. 3B is a schematic side view of the substrate of the straw according to another embodiment of the present invention. FIG. 4 is a schematic diagram of a flattened shape of a substrate when flattened according to one embodiment of the present invention, which also shows a partial enlarged view of an end of the straw.

Please refer to FIGS. 1A-4, which show a straw 1 comprising a tubular straw body 11 having an end 12 and formed of a substrate 2, wherein the substrate 2 has a first long side 13, a second long side 14, and a first thickness t1, the first long side 12 overlaps with the second long side 14 to form an overlapping portion 3 having a second thickness t2. The end 12 is formed after the overlapping portion 3 is sealed to form the tubular straw body 11. In accordance with an embodiment of the present invention, the overlapping portion 3 is sealed by heating the degradable coating 4 using an ultrasonic machine. The degradable coating 4 melts when the ultrasonic waves generated by the ultrasonic machine is applied so that the molten degradable coating 4 on the top surface of the substrate 2 adhere to the back surface of the substrate 2. The degradable coating 4 is a non-plastic material, which is different from the prior plastic coating materials such as PE, PP, PET and PAL. Because the straws made of paper according to the present invention do not contain a plastic coating, the paper straws can be recycled to obtain pulp with reduced cost, which can then be reused to produce new paper straws. Candidate for the degradable coating material is a water based coating material or a functional packaging coating material, such as polyacrylic acid, and functions as a good water barrier. Both materials of the degradable coating 4 and the substrate 2 are at least one of water degradable and bacterial degradable. According to a preferable embodiment of the present invention, the materials of the degradable coating 4 and the substrate 2 are both water degradable and bacterial degradable.

When sealed by the heating, the overlapping portion 3 is applied by an external force or a pressure, for example, exerted by a fixing part and a movable part, each disposed below and above the overlapping portion 3. Preferably, the fixing part is a fixed rod as a core provided inside the hollow core of the scrolled substrate 2 and parallel to the longitudinal direction LD. The fixed rod is cylindrical, and can be made of a metal, such as iron or stainless steel. the movable part is an ultrasonic head installed below an ultrasonic generator module. When performing the heating and sealing process, the ultrasonic head and the ultrasonic generator, functioning as a pressing object, will move downward and press on the overlapping portion 3. When the first long side 13 and the second long side 14 gradually converge and overlap to form the scrolled substrate 2 having the overlapping portion 3, the scrolled substrate 2 is moving along the inside of a guiding tube and encompassing the fixed rod provided in the hollow core of the scrolled substrate 2, and the pressing object presses on the overlapping portion 3 and exerts the force or pressure onto the overlapping portion 3 against the fixed rod when the overlapping portion 3 is heated and sealed. The ultrasonic head conducts ultrasonic waves from the ultrasonic generator and generates heat onto the overlapping portion 3. The degradable coating 4 on the overlapping portion 3 of the substrate 2 is heated and melted, thereby adhering and forming the overlapping portion 3. An external force, such as, due to gravity, the weight of the ultrasonic head plus the weight of the ultrasonic generator, is exerted on the overlapping portion 3 against the fixed rod. The pressure exerted by the external force is in the range of about 100˜250 kg·m/s².

Accordingly, the overlapping portion 3 becomes denser and tougher than the substrate 2 itself, so a ratio of the second thickness t2 to the first thickness t1 is smaller than 2. Based on the present invention, because the overlapping portion 3 of the straw 1 is subjected to a force or pressure when being heated and sealed, the material density of the overlapping portion 3 is higher than that of the non-overlapping portion 5 of the substrate 2 (the non-overlapping portion 5 has the first thickness t1), the liquid absorption rate is reduced, and therefore the durability against liquids is higher than that of the straw not subjected to the force or pressure. This effect achieved by the present invention is advantageous over the prior art.

Moreover, the degradable coating 4 serves as a medium to seal the overlapping portion 3, and no adhesive material is required. The material selected for the degradable coating 4 is water-based, and helps it easily decompose in the natural environment, and so it can be recycled. This effect achieved by the present invention is advantageous over the prior art.

Please refer to FIG. 1A and FIG. 4, which show that the straw 1 of the present invention has the end 12 having a plane vertical to the longitudinal direction LD of the straw 1. Please refer to FIG. 1B and FIG. 4, which show that the straw 1 of the present invention has the end 12 having a plane inclined to the longitudinal direction LD of the straw 1. In addition, please refer to FIG. 3, which shows that the straw 1 of the present invention has the overlapping portion 3 having two longitudinal sides 31 and 32 being straight, and one (e.g. the first longitudinal side 31) of the two longitudinal sides 31 and 32 is in a straight line with the sharp point/tip 16 of the straw 1. After the process of scrolling the substrate 2 into a circular tube, the scrolled substrate 2 is then sealed and cut to form the straw 1 as shown in FIG. 1A or FIG. 1B. Based on the present invention, because the first longitudinal side 31 is in a straight line with the sharp point 16, the sharp point is strengthened because the sharp point has at least a part of the overlapping portion 3. Therefore, the sharp point 16 of the straw 1 can more easily pierce the sealing film on the portable paper cup. The sealing film is heat-sealable, and is generally one of an ES film, an AP film, a PP film, a PE film, and a paper film. This effect achieved by the present invention is advantageous over the prior art.

Please refer to FIG. 2, which shows that the straw 1 has a nominal diameter D being 4 mm, 6 mm, 8 mm, 10 mm or 12 mm, but it is not limited thereto.

According to one embodiment of the present invention, the substrate 2 is made of fluorene-free paper, and the paper is food grade. Therefore, the paper straw of the present invention is harmless to the human body and is beneficial to environmental protection. In addition, the present invention applies to the straw made of a plastic material as well.

Please refer to FIG. 3A, which shows that the substrate 2 has a first surface 21 coated with a degradable coating 4. The degradable coating 4 has a third thickness t3 ranging from 0.014 mm to 0.020 mm, which corresponds to the weight of the degradable coating 4 ranging from 10 g/m² to 15 g/m². The degradable coating 4 is at least one of hydrolytically degradable and bacteria decomposable. In addition, the degradable coating 4 is one of waterproof and non-waterproof, and is preferably waterproof.

In accordance with another embodiment of the present invention, as shown in FIG. 3B, the substrate 2 has a second surface 22 coated with the degradable coating 4.

Please refer to FIG. 4, which shows that the substrate 2 has a first short side 15 having a first width W1, the overlapping portion has an overlapping width W2, and a ratio of the overlapping width W2 to the first width W1 ranges from 0.051 to 0.131.

Please refer to FIG. 1C and FIG. 4. The substrate 2 has a first short side 15 in a zigzag shape, wherein the first short side 15 consists of a first edge 151, a second edge 152 and a third edge 153. The first edge 151 has a first sub-length L1, and the second edge 152 has a second sub-length L2. The first edge 151 and the third edge 153 overlap with each other to form an overlapping edge 30 of the overlapping portion 3. The first edge 151 and the second edge 152 have a same acute angle θ (theta) with respect to a longitudinal direction LD of the tubular straw body 11. In order to allow the straw 1 to better pierce the sealing film covering a portable paper cup, the acute angle θ preferably ranges from 35° to 65°.

Please refer to FIG. 1C, FIG. 2 and FIG. 4. When looking at the overlapping edge 30, the first long side 13 may be on top of the second long side 12; or alternatively, it is also applicable for the second long side 12 to be on top of the first long side 13. The first sub-length L1 is equal to the second sub-length L2.

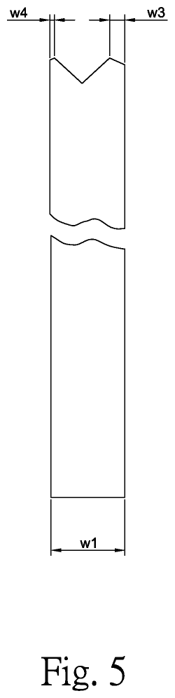

When the straw 1 is formed by cutting a circular tube of the substrate 2 to form the end 12 inclined to the longitudinal direction LD of the tubular straw body 11, there may be a tolerance for the cutting error. As shown in FIG. 1C, it is in the case that the first longitudinal side 31 is in line with the sharp point 16. According to another embodiment of the present invention, the first longitudinal side 31 is a little bit deviated from the sharp point 16, and thus the first longitudinal side 31 is not in a straight line with the sharp point 16. FIG. 5 is a schematic diagram of a flattened shape of a substrate when flattened according to another embodiment of the present invention, which also shows a partial enlarged view of an end of the straw. When the cutting has the cutting error, the flattened shape of the substrate is shown in FIG. 5, wherein the overlapping width W2 is composed of a third width W3 labelled near the first long side 13, and a fourth width W4 labelled near the second long side 14. Because the substrate 2 is scrolled into a tubular shape and sealed to form the sealed scrolled substrate 2 having the overlapping portion 3 before forming the straw 1, and the nominal diameter D for straws 1 are the same, and also the circumference of straws 1 remains the same, when the straw 1 is flattened to see its top view, the overlapping width W2 is equal to W3 minus W4. In other words, if the first longitudinal side 31 is in a straight line with the sharp point 16, then W4 is zero, and W3 equals to W2, whereas if the first longitudinal side 31 is deviated from the sharp point 16, then W3 is larger than W2, and W4 equals to W3 minus W2. Because of the cutting deviation/tolerance, the value of W4 is in the range of 0-1.0 mm for the substrate having the first width W1 being 43 mm, 29 mm or 23 mm. The physical meaning of W4 is the distance between, e.g., the first longitudinal side 31 and a virtual straight line passing through the sharp point 16 and parallel to the longitudinal direction LD. Accordingly, the deviation that the first longitudinal side 31 deviated from the virtual straight line ranges from 0-1.0 mm, as the value of W4 mentioned above.

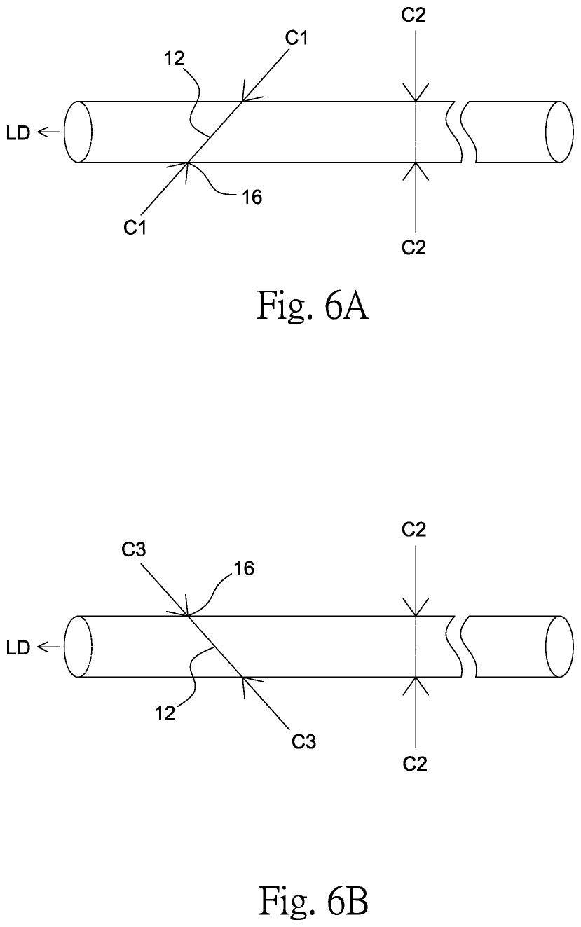

FIG. 6A and FIG. 6B are schematic diagrams showing how to cut to form a straw 1 according to two different embodiments of the present invention. Please refer to FIG. 6A and FIG. 6B, which show the two directions for the sealed scrolled substrate 2 to be cut. Two cutting lines are along C1-C1 and C2-C2, wherein the cutting line C1-C1 is inclined, and the cutting line C2-C2 is vertical to the longitudinal direction LD. The difference between FIG. 6A and FIG. 6B is that after cutting the sealed scrolled substrate 2, the obtained straw 1 is bevel up or bevel down at the end 12. As shown in FIG. 6B, the sealed scrolled substrate 2 is cut along two cutting lines C3-C3 and C2-C2.

### Test Results

Straws having the paper substrate thickness of 0.265 mm and 0.295 mm are tested, with the degradable coating on both surfaces of the paper substrate.

### 1. Thickness Measurement to the Substrate Thickness t1 and the Overlapping Portion t2

| Substrate thickness, t1 | 0.265 mm | 0.295 mm |
|---|---|---|
| Thickness of | 0.38 mm | 0.53 mm |
| overlapping portion, t2 | | |
| Ratio of t2/t1 | 1.4340 | 1.7966 |

It can be seen that the ratio of the thickness of overlapping portion to the substrate thickness is about 1.4 to 1.8.

### 2. Width of the Overlapping Portion

| | | | | | | |
|---|---|---|---|---|---|---|
| Nominal | 12 | 12 | 8 | 8 | 6 | 6 |
| diameter, D | | | | | | |
| (mm) | | | | | | |
| First width | 43 | 43 | 29 | 29 | 23 | 23 |
| of substrate, | | | | | | |
| W1 (mm) | | | | | | |
| Overlapping | 3.3 | 2.3 | 2.5 | 1.5 | 3 | 2 |
| width, W2 | | | | | | |
| (mm) | | | | | | |
| Ratio of | 0.076744 | 0.053488 | 0.086207 | 0.051724 | 0.130435 | 0.086957 |
| W2/W1 | | | | | | |

It can be seen that the ratio of the overlapping width W2 to the first width W1 of the substrate ranges from about 0.051 to 0.131.

### 3. Piercing Test for the Sealing Film of a Paper Cup Having Different Paper Thicknesses

| Sealing film | 0.265 mm thick | 0.295 mm thick |
|---|---|---|
| ES film | ◯ | ◯ |
| AP film | ◯ | ◯ |
| PP film | ◯ | ◯ |
| PE film | ◯ | ◯ |
| paper film | ◯ | ◯ |

Remarks: “◯” means pass; and
“X” means fail

It can be seen that the test straws of the present invention successfully pierce all kinds of the sealing film.

### 4. Soaking Test Results for the Sealing Film of a Paper Cup Having Different Paper Thicknesses

Straws of the present invention are soaked in water at room temperature for the test. Straws of another maker having similar thicknesses are also tested as comparative examples.

| | Substrate | | | | | | |
|---|---|---|---|---|---|---|---|
| | thickness, | | | | | | |
| | t1 | Soaking time (hr.) | | | | | |
| | (mm) | 2 | 4 | 8 | 24 | 36 | 48 |
| Example 1 of | 0.265 | ◯ | ◯ | Δ | Δ | Δ | Δ |
| the present | | | | | | | |
| invention | | | | | | | |
| Example 2 of | 0.28 | ◯ | ◯ | Δ | Δ | Δ | Δ |
| the present | | | | | | | |
| invention | | | | | | | |
| Example 3 of | 0.295 | ◯ | ◯ | Δ | Δ | Δ | Δ |
| the present | | | | | | | |
| invention | | | | | | | |
| Comparative | 0.25 | Δ | X | X | X | X | X |
| Example 1 of | | | | | | | |
| another maker | | | | | | | |
| Comparative | 0.28 | Δ | Δ | X | X | X | X |
| Example 2 of | | | | | | | |
| another maker | | | | | | | |
| Comparative | 0.3 | Δ | Δ | X | X | X | X |
| Example 3 of | | | | | | | |
| another maker | | | | | | | |
| Comparative | 0.34 | Δ | Δ | Δ | X | X | X |
| Example 4 of | | | | | | | |
| another maker | | | | | | | |

Remarks: “◯” means pass; and
“Δ” means softened but not decomposed
“X” means fail, e.g. softened and decomposed

It can be seen that the test straws of the present invention have a better durability to water than those of another maker. According to the test results, the soaking time/duration that the test straws having the thicknesss of 0.265 to 0.295 in Examples 1-3 of the present invention each is not decomposed is longer than 48 hours, while those for the test straws having the thickness of 0.25 mm to 0.34 mm in the comparative Examples 1-4 are about 2 hours, 4, hours and 8 hours respectively. Accordingly, the soaking time/duration for the straws not being decomposed for the present invention is more than 24 times (which is calculated by 48 hr./2 hr.) or at least 6 times (which is calculated by 48 hr./8 hr.) longer than those of another maker.

Based on the above, it can be realized that firstly, the straws according to the present invention has higher durability against liquids because the overlapping portion of the straw is subjected to a force or pressure when being heated and sealed, so that the material density of the overlapping portion is higher than that of the non-overlapping the substrate. Secondly, the straws according to the present invention has a higher strength at the sharp point to more easily pierce the sealing films, such as an ES film, an AP film, a PP film, a PE film, and a paper film, on the portable paper cup because the first longitudinal side 31 is in a straight line with the sharp point 16, or almost in a straight line with the sharp point 16. Thirdly, because the straws according to the present invention are cut into the product after scrolling and sealing the substrate, the process for manufacturing the straws of the present invention is much simpler than that of the prior art. Fourth, the paper straw according to the present invention is harmless to the human body and is beneficial to environmental protection. Fifth, because the paper straws of the present invention do not contain plastic coating, the paper straws can be recycled to obtain pulp, which can then be reused to produce new paper straws, thereby reducing the cost for recycling paper material and that for reproducing paper straws. The above effects are unexpected or not achieved by the prior art.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A straw, comprising:
a tubular straw body having an end and formed of a substrate, wherein the substrate has a first long side, a second long side and a first thickness, the first long side overlaps with the second long side to form an overlapping portion having a second thickness, characterized in that:
a ratio of the second thickness to the first thickness is smaller than 2.

2. The straw according to claim 1, wherein the ratio ranges from 1.43 to 1.8.

3. The straw according to claim 1, wherein the straw has a nominal diameter being one selected from a group consisting of 4 mm, 6 mm, 8 mm, 10 mm and 12 mm.

4. The straw according to claim 1, wherein the substrate is made of paper.

5. The straw according to claim 4, wherein the paper has a food grade.

6. The straw according to claim 1, wherein the substrate has a first surface coated with a degradable coating.

7. The straw according to claim 6, wherein the degradable coating has a third thickness ranging from 0.014 mm to 0.020 mm.

8. The straw according to claim 6, wherein the degradable coating is at least one of hydrolytically degradable and bacteria decomposable.

9. The straw according to claim 6, wherein the overlapping portion is sealed by heating the degradable coating using ultrasonic waves.

10. The straw according to claim 6, wherein the degradable coating is waterproof.

11. The straw according to claim 10, wherein the degradable coating is water-based.

12. The straw according to claim 6, wherein the substrate has a second surface coated with the degradable coating.

13. The straw according to claim 1, wherein the substrate has a first short side having a first width, the overlapping portion has an overlapping width, and the straw is further characterized in that:
a ratio of the overlapping width to the first width ranges from 0.051 to 0.131.

14. The straw according to claim 1, wherein the substrate has a first short side in a zigzag shape, the first short side consists of a first edge having a first sub-length, a second edge having a second sub-length and a third edge, the first edge overlaps with the third edge to form an overlapping edge of the overlapping portion, and the first sub-length is equal to the second sub-length.

15. The straw according to claim 14, wherein the first edge and the second edge have a same acute angle with respect to a longitudinal direction of the tubular straw body, and the same acute angle ranges from 35° to 65°.

16. The straw according to claim 1, wherein the overlapping portion has two longitudinal sides being straight.

17. The straw according to claim 16, wherein the end of the tubular straw body has a beveled end having a sharp point, and one of the two longitudinal sides is in a straight line with the sharp point.

18. The straw according to claim 16, wherein the end of the tubular straw body has a beveled end having a sharp point, and one of the two longitudinal sides is not in a straight line with the sharp point wherein the straight line is parallel to the axis of the longitudinal axis of the straw.

19. The straw according to claim 16, wherein a distance between one of the two longitudinal sides and a virtual straight line passing through the sharp point and parallel to a longitudinal direction of the tubular straw body ranges from 0-1.0 mm.

20. The straw according to claim 1, wherein a material density of the overlapping portion is larger than that of a non-overlapping portion of the substrate, wherein the non-overlapping portion has the first thickness.
